(19) United States
(12) Patent Application Publication
(10) Pub. No.: US 2024/0239976 A1
(43) Pub. Date: Jul. 18, 2024

(54) PRODUCING POLYHYDROXYALKANOATE (PHA) BLOWN FILM

(71) Applicant: Plastic Suppliers, Inc. dba Earthfirst, Columbus, OH (US)

(72) Inventors: Tom Bowden, Columbus, OH (US); Ed Tweed, Columbus, OH (US)

(21) Appl. No.: 18/414,399

(22) Filed: Jan. 16, 2024

Related U.S. Application Data
(60) Provisional application No. 63/439,019, filed on Jan. 13, 2023.

(51) Int. Cl. C08J 5/18; B29C 48/00; B29C 48/08; B29C 55/28; B29K 67/00; B29K 105/00; C08K 3/36; C08K 5/20; C08L 67/04

(52) U.S. Cl. CPC C08J 5/18; B29C 48/0018; B29C 48/022; B29C 55/28; C08K 3/36; C08K 5/20; C08L 67/04; B29C 48/08; B29K 2067/00; B29K 2105/0005; B29K 2105/0094; C08J 2367/04; C08J 2471/02; C08L 2203/16

(57) ABSTRACT

A method for producing polyhydroxyalkanoate (PHA) blown film comprising the steps of melting PHA material to form a molten mass with a viscosity ranging from 1400 P to 1600 P at 340° F. to 350° F. (melting point of PHA), forming a bubble from the resulting molten mass and collapsing the bubble to form a film. Furthermore, due to the tight processing window or PHA compared to other blown films, PHA benefits from being produced using an enclosed climate-controlled blown film process as the climate can be controlled within the enclosure to ensure the tight processing window is maintained.

### CROSS-REFERENCE TO RELATED APPLICATIONS

This application claims priority to U.S. Provisional Application No. 63/439,019 entitled “PRODUCING POLYHYDROXYALKANOATE (PHA) BLOWN FILM”, filed Jan. 13, 2023, the entire contents of which are incorporated by reference herein.

### FIELD OF THE DISCLOSURE

The present disclosure is generally related to a method for making a polyhydroxyalkanoate (PHA) blown film. Specifically, the PHA blown film is made using a climate-controlled enclosed process, wherein the climate during the bubble and collapsing phases are controlled in order to allow for controlled cooling of the bubble and prevent defects or impurities.

### BACKGROUND

Current biopolymer blown films such as polylactic acid (PLA) have desirable characteristics but are only compostable in industrial facilities. This limits the marketability of such films as well and raises the environmental impact.

Polyhydroxyalkanoate (PHA) is a biopolymer that is much more easily composted when compared to PLA. PHA can be composted at home.

However, PHA can be more difficult to manufacture as a blown film when compared to PLA due to a much tighter processing window. Specifically, PHA blown film has a narrow processing window (340° F. to 348° F.) as there is a steep drop off of it being workable into a film outside that range. Stickiness is another specific issue but can be mitigated with additives. Other difficulties include the melting temperature/point, difficulty opening the “bubble”, difficulty to metalize, etc.

### SUMMARY OF THE INVENTION

Provided herein is a method for making a PHA blown film. The method comprises melting a composition including dry pellets comprising PHA to form a molten mass at a first viscosity from about 1400 P to about 1600 P at a first temperature from about 340° F. to about 350° F. at an apparent shear rate of about 55 s¹; increasing the viscosity of the molten mass to a second viscosity; forming a bubble from the resulting molten mass within a climate-controlled enclosure; and collapsing the bubble to form a PHA blown film. The step of increasing the viscosity of the molten mass may include cooling the molten mass. The method may further comprise extruding the molten mas prior to increasing the viscosity of the molten mass. The method may further comprise drying the composition. The method may further comprise annealing the PHA film. The PHA film may be substantially free of a plasticizer.

### BRIEF DESCRIPTION OF THE DRAWINGS

FIG. 1 illustrates a PHA blown film processing system, according to an embodiment of the present disclosure.

FIG. 2 illustrates a blown film process, according to an embodiment of the present disclosure.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

The processes described herein produces a PHA film having reduced stickiness by adding wax to the PHA film. To further improve the film, the PHA film of the present disclosure may be produced in an enclosed blown film process as described herein. This allows for more control during the manufacturing process, specifically, during the cooling of the blown film. The controlled process reduces defects and inconsistencies in the blown film. Furthermore, most PLA films are not easily compostable or are only compostable in industrial facilities, whereas a PHA film of the present disclosure may be composted at home.

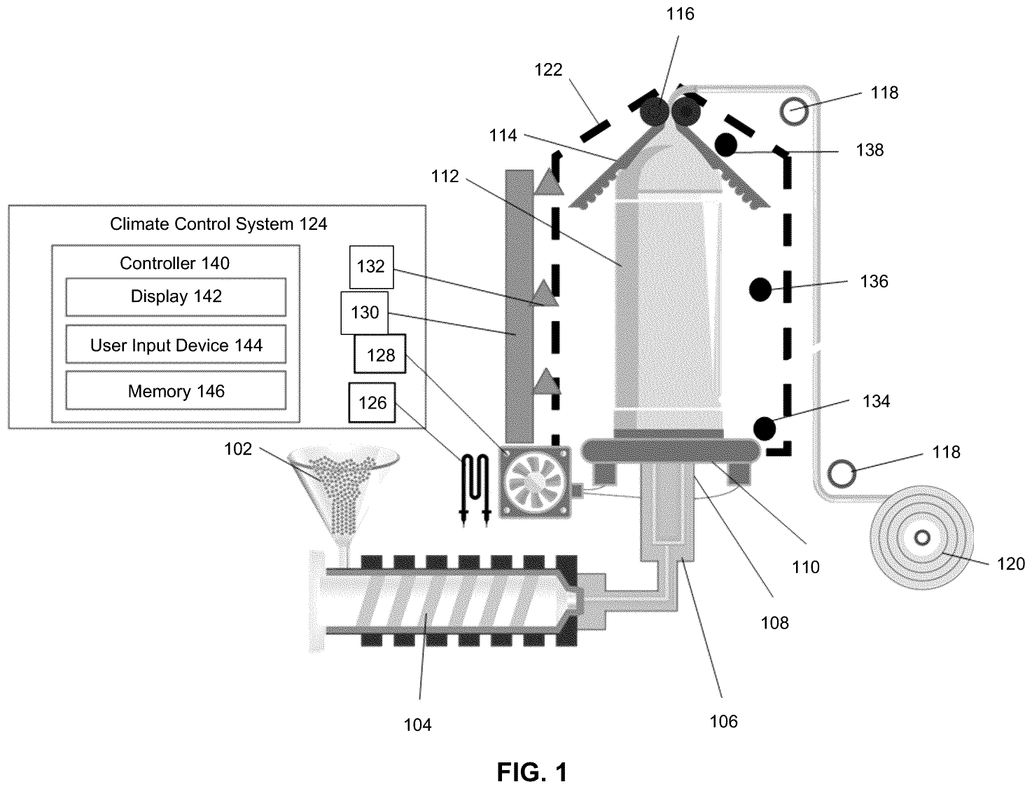

FIG. 1 shows a system for producing a biopolyester blown film. This system comprises a hopper 102. The hopper 102 is a container for bulk polymer material such as polymer pellets, grains, or beads, which tapers downward to a discharge point at the bottom where the bulk material is discharged into a extruder 104. The bulk polymer material includes PHA, or a blend of PHA and one or more additional biopolyesters (also referred to as a PHA blend baseblend base). The bulk polymer material may be dried in a variety of different ways, including, for example, drying in a dehumidifying hopper. In one embodiment, the hopper 102 may include a dehumidifying element, such as a dehumidifying hopper with hot air at a relatively low dew point. However, a variety of air dryers are known in the art and many of them may be suitable for drying. The present invention need not be limited to air dryers only but may include other types of dryers, including baking ovens. A dehumidifying hopper may be desirable in some embodiments in that dehumidified air passes through a bed of the bulk polymer material to extract moisture from the bulk polymer material.

The dehumidifying hopper may include a desiccant material, such as silica, to absorb moisture from the circulating air. Dual desiccant bed systems may be used, so that one bed is on-stream while the stand-by bed is being regenerated. Either a time cycle or a predetermined decrease in air dew point is used to shift airflow from one bed to the other. Such methodology may remove some moisture that may reside below the surface of the bulk polymer material in addition to the surface moisture.

The extruder 104 receives the bulk polymer material from the hopper 102. The extruder 104 then extrudes the material through a annular die 108. During the extrusion process, the pellets are melted and homogenized before they are pumped through a annular die 108. The pellets are melted into a low viscosity molten mass, thus combining the heretofore individual polymer or biopolymer pellets, beads, or grains into one molten mass. The viscosity of the melt will depend on the temperature. Temperatures can range from about the temperature at which the polymers will remain melted to about the temperature where degradation of the polymers begins to occur.

A polymer cooler 106 for cooling the polymer extrudate may optionally be used in some systems of the present disclosure. By way of example, the viscosity of biopolymers at about 480° F. and an apparent sheer rate of about 5.5 seconds⁻¹ in a capillary rheometer may range from about 1,000 poise (P, dyne/cm²) to about 8,000 P, preferably about 3,000 P to about 6,000 P, and more preferably, about 4,500 P. At a shear rate of about 55 seconds⁻¹, the same polymer at about 480° F. may have an apparent viscosity that ranges from about 1,000 P to about 5,000 P, preferably about 2,000 P to about 4,000 P, and more preferably, about 3,000 P. The polymer cooler 106 conditions the temperature of the polymer to increase the viscosity of the molten polymers, which makes the melt manageable for further processing. The cooling allows for the temperature of the extruded polymer to drop to a level at which the corresponding viscosity is high enough to allow a bubble to be blown. By increasing the viscosity, a smoother film surface than without this step may be generated. A smoother surface aids in the printing process that is performed in many end applications, such as, for example, labels.

The polymer cooler 106 may include any cooler (i.e., heat exchanger) known in the art. The cooling medium may include air, liquids, or a polymeric coolant. For example, the viscosity of the polymer melt may be adjusted, alone or in combination, for example, by air cooling the die inner mandrel through which the polymer film is blown, the use of viscosity enhancers noted below, controlling the die temperature with air or liquids, or polymer coolers.

In another embodiment, the polymer cooler 106 operating temperature range is preferably between about 280° F. to about 450° F. Higher temperatures may be used, but such higher temperatures may also contribute to the degradation of the polymer. The temperature and duration of cooling may depend on both the amount of polymer being cooled and the film properties that may be desired. In an embodiment involving polystyrene cooling, the pressure in the primary loop is generally about 1000 psi to about 7,000 psi. The pressure in the same loop adjusted for PHA use may range from about 300 psi to about 4,000 psi.

In one example, the viscosity of PLA at 320°−360° F. and an apparent sheer rate of about 5.5 seconds⁻¹ in a capillary rheometer, may range from about 15,000 P to about 17,000 P, preferably about 15,500 P to about 16,500 P, and more preferably, about 16,000 P. At a shear rate of about 55 seconds⁻¹ the same polymer at 3750 F may have an apparent viscosity that ranges from about 14,000 P to about 16,000 P, preferably about 16,500 P to about 15,500 P, and more preferably, about 15,000 P. The polymer cooling step can increase the viscosity from anywhere from about 2 to about 10 times that of the polymer coming out of the extruder.

The extruded polymers demonstrate a substantial increase in viscosity upon cooling in the polymer cooler 106, which cooling procedure, in part, is thought to allow for the subsequent blowing of the film. The viscosity of the PHA polymers exhibits a consistent shear viscosity of a relatively large range of shear rates at any given temperature.

The annular die 108 is used for the shaping of polymer products, such as in a pipe extrusion process, extrusion blow molding process, and blown film extrusion process. In this part of the system, the polymer melt is already pre-cooled, preferably in a polymer cooler 106, and then submitted to a blown film orientation process. However, the viscosity of the polymer melt may also be adjusted, alone or in combination, for example, by air cooling the annular die 108 inner mandrel, the use of viscosity enhancers, and liquid thermoregulation of the annular die 108. In another embodiment a pre-cooling step may be implemented but is not necessary.

The system of the present invention has at least one significant advantage in that a very controlled temperature—from the post extrusion temperature conditioning-can be achieved prior to the formation of a bubble. A blown film extrusion process extrudes molten polymer through the annular die 108 of circular cross-section and uses an air jet to inflate a bubble comprising the same.

Annular die 108 parameters may range from 1:0.75 BUR (Blown Up Ratio) to about 1:7.0 BUR, and preferably, about 1:4 BUR in the cross-web direction. In the length (or machine) direction, annular die 108 parameters may range from about 1:1 drawdown ratio to about 1:300 drawdown ratio, and preferably, about 1:130 drawdown ratio.

In a preferred embodiment then, by virtue of pre-cooling the melted polymer, only a final fine-tuning of orienting temperature is performed, where desired, during the orientation process. In other words, the greater share of temperature conditioning takes place prior to orienting and not during orienting. Where a fine-tuning of temperature is desired, it can be relatively easily accomplished by a temperature-controlled air ring 110, which blows chilled air at the base of the bubble. Air can be blown both on the outer surface of the bubble 112 at the air ring 110 or internal to the bubble 112. This internal and outer surface cooling is beneficial as it creates even cooling around the bubble 112. Furthermore, as will be discussed later on, further control of the cooling process once the bubble 112 has been created may improve the final film product and allow for the use of other biopolymers and biopolymer blends.

Once the extrudate has been inflated into a circular bubble 112, it then is “collapsed” into a double thickness film. The collapsing process is performed by use of an “A-frame,” also known as a collapsing frame 114. The collapsing frame 114 uses primary nip rollers 118, panels, and/or flat sticks to flatten the bubble 112 into a sheet of double-thickness film. The sheets are ultimately cut and wound onto two finished rolls, or coils, or winder rollers 120. The sheets of film may also be cut to the desired length.

The primary nip rollers 116 flatten the bubble 112 into a sheet of double-thickness film. In one embodiment the primary nip rollers 116 may be placed and designed in such a way that they do not allow any air to pass through. The primary nip rollers 116 may be placed at the very top of the enclosure 122 when the film process is oriented in an upward direction. By limiting air from escaping through the primary nip rollers 116, the internal temperature of the enclosure 122 may be better controlled.

The secondary nip rollers 118 are located after the primary nip rollers 116 to assist with moving the film along the line. In another embodiment, additional nip rollers may be used to further assist in moving the film along the production line. The winder rollers 120 wind the collapsed film after coming through the secondary nip rollers 118.

The enclosure 122 is a casing or exterior shell that encloses the blown film process. The enclosure 122 encases the film blowing process from the annular die 108 up to the primary nip rollers 116. The enclosure 122 surrounds the blown film tower and includes at least a heating/cooling element 126 to maintain an optimal temperature for the blown film process. In another embodiment, the enclosure 122 does not encase the entire film blowing process but starts just after the bubble 112 is formed and encases the process up to the primary nip rollers 116. In another embodiment, the enclosure 122 is separated into several zones where the temperature in each zone is monitored and controlled separately in each zone by temperature sensors (134, 136, 138) and separate air ducts 130 and air vents 132.

By enclosing the bubble 112 as it is being created or just after it is created and providing more control over the heating/cooling of the film with the enclosure 122, the temperature or climate (i.e. humidity) of or around the blown film may be controlled through the entire process. This is novel in the blown film process and further, allows for a wider range of polymer/biopolymers or blends to be used in the blown film process. Without an enclosure 122 and a climate control system 124, some polymers may cool too quickly or not quickly enough causing defects, impurities, or tearing of the film.

The climate control system 124 is used to maintain optimal temperatures and humidity within the enclosure. The climate control system 124 includes one or more heating/cooling elements 126, one or more blowers 128, air ducts 130, air vents 132, a first temperature sensor 134, a second temperature sensor 136, a third temperature sensor 138, and a controller 140. The climate control system 124 may be located outside of the enclosure 122. In another embodiment, the climate control system 124 may dehumidify the bulk polymer material in the hopper 102 as polymers and biopolymers are known to absorb or attract moisture. Furthermore, the climate control system 124 may control the humidity throughout the entire system.

The heating/cooling element 126 may include a heating electric coil or other means of heating air. Alternatively, the heating/cooling element 126 may include an air conditioning unit to cool the air. In another embodiment, there are at least two heating/cooling elements 126, which allows the climate control system 124 to control the temperature of the air moving to different sections of the enclosure. A heating/cooling element 126 for each temperature sensor may be included to allow for individual control of temperature to each section of the enclosure where each temperature sensor is located.

The blower 128 moves heated or cooled air from the heating/cooling element 126 through the air ducts 130 and air vents 132 to different sections of the enclosure. In another embodiment, there are at least two blowers 128, for example, one for each of the temperature sensors so that air may be individually forced or routed to the area of each temperature sensor. The air ducts 130 channel heated or cooled air from the heating/cooling element 126 and blowers 128 to different portions of the enclosure 122. This allows for heated forced air to be distributed and directed to different sections of the enclosure 122 to ensure ideal climate control throughout the enclosure 122. For example, a blown film process may benefit from maintaining a certain temperature through the initial phase of the bubble phase and then cooled quickly just before the bubble 112 is collapsed or during the collapsing process. With the system of the present disclosure, the climate control system 124 may maintain a certain temperature during the first phase of the bubble process and then inject cooler air via the air ducts 130 towards the end of the process or as the bubble 112 is collapsed. The air vents 132 open from the air ducts 130 and help direct and regulate the airflow into the enclosure 122. The air vents 132 can be controlled by the controller 140 to help direct airflow by opening and closing the air vents 132 or directing the airflow.

The system of the present disclosure includes at least one temperature sensor. A temperature sensor is an electronic device that measures the temperature of its environment and converts the input data into electronic data to record, monitor, or signal temperature changes. There are many different types of temperature sensors. Some temperature sensors require direct contact with the physical object that is being monitored (contact temperature sensors), while others indirectly measure the temperature of an object (non-contact temperature sensors). The system shown in FIG. 1 includes three temperature sensors (134, 136, 138). The first temperature sensor 134 monitors temperature within the enclosure 122. In the embodiment shown in FIG. 1, the first temperature sensor 134 is one of at least three sensors that are located at different points within the enclosure 122. In one embodiment the first temperature sensor 134 is located just above the air ring 110 but before the bubble 112 is fully formed. In some embodiments, the first temperature sensor 134 monitors the temperature within the enclosure 122 just above the air ring 110. The monitored temperature is electrically communicated (e.g., wired or wirelessly, including WiFi, Bluetooth, or other transmission mediums) back to the controller 140 which uses the temperature data to regulate air temperature within the enclosure 122 at the location.

The second temperature sensor 136 monitors temperature within the enclosure 122. The second temperature sensor 136 is one of at least three sensors that are located at different points within the enclosure 122. In one embodiment the second temperature sensor 136 is located at a mid-point of the enclosure 122. In another embodiment where the enclosure 122 doesn't fully enclose the process down to the air ring 110, the second temperature sensor 136 may be located at a point just as the bubble 112 enters the enclosure 122. The second temperature sensor 136 monitors the temperature and the monitored temperature is electrically communicated (like that of sensor 134) to the controller 140, which uses the temperature data to regulate air temperature within the enclosure 122 at the location of the second temperature sensor 136.

The third temperature sensor 138 monitors temperature within the enclosure 122. The third temperature sensor 138 is one of at least three sensors that are located at a different point within the enclosure 122 along the film blowing process. In one embodiment the third temperature sensor 138 is located just before the primary nip rollers 116 just before the bubble 122 is collapsed. The third temperature sensor 138 monitors the temperature within the enclosure 122 just before the primary nip rollers 116. The monitored temperature is sent back to the controller 140, which uses the temperature data to regulate air temperature within the enclosure 122 at the location of the third temperature sensor 138.

The controller 140 includes a display 142, a user input device 144 or user interface, and memory 146. The controller 140 is used to program and control the climate control system 124. A user may select pre-stored settings or enter in a specific settings and the controller 140 then monitors the temperature data from the temperature sensors (134, 136, 138). Depending on data received from the sensors, the controller 140 may adjust the temperature and the airflow entering the enclosure 122 by adjusting the temperature of the heating/cooling element 126, the output of the blower 128, and the air vents 132.

The display 142 is used to display data and user inputs. Displayed data may include, but are not limited to, sensor data, such as temperature, blower or fan speeds, or other data related to the film blowing process. The user input device 144 or user interfaces are well known in the art and may include, but are not limited to, keyboards, touch screens, voice, or other connected devices such as smartphones or tablets.

The memory 146 is a device or system that is used to store information for immediate use in a computer or related computer hardware and digital electronic devices. The term memory is often synonymous with the term primary storage or main memory. The memory 146 stores data from the sensors and other devices connected to the film blowing process. Furthermore, the memory 146 may store user input information from the user input device 144, a preset configuration such as temperature ranges or thresholds, and executable code or modules.

The PHA blown film is a blown film with a wax additive that helps reduce the stickiness of the PHA film if were used alone. The PHA film may further comprise a PHA blend base, a slip additive, an antiblock additive, a processing aid, and a wax PHA based bioplastics can be blended in different ways or in combination with different additives to obtain specific desired properties. PHA blown films alone are often much too sticky and unmanageable, limiting their use and marketability. Furthermore, the PHA blown film benefits from the previously described enclosed blown film process. The enclosed blown film process allows for a climate-controlled process where the temperature during the bubble 112 formation or blowing may be controlled allowing for a higher quality finished product with fewer defects or inconsistency. Since different elements of the PHA blown film may have different cooling temperatures or different cooling rates, an enclosed system greatly benefits the production of the film. The resulting film is an improvement on other similar films as it is flexible, allows for elongation, has significant clarity, ductility, stability, is the appropriate thickness for packaging, home or marine compostable, heat-stable (i.e. can be printed), differential temperatures (i.e. has sealing characteristics), and allows for jaw release (a result of slip additive).

The PHA blend base may include a blend baseblend base of PHA and at least one additional polyester selected from polylactic acid (PLA) (such as poly(L-lactic acid) (PLLA), poly(D-lactic acid) (PDLA), poly(D,L-lactic acid) (PDLLA) or PLA stereocomplex (scPLA)), polyglycolic acid (PGA), polycaprolactone (PCL), polybutylene succinate (PBS), polybutylene succinate adipate (PBSA), polybutylene adipate terephthalate (PBAT), and derivatives or blends/mixtures thereof. The PHA blend may comprise no more than 50 wt % of the additional biopolyester, such as about 50 wt %, about 40 wt %, about 30 wt %, about 20 wt %, about 10 wt %, about 5 wt %, about 1 wt %, or about 0.1 wt % of the additional biopolyester. In some embodiments, a PHA base containing no additional biopolyesters may be used. The wax is an additive to the PHA blown film which reduces the stickiness of the PHA blown film. The wax additive may include, but is not limited to, an EBS (ethylene-bis staramide) synthetic wax. In one embodiment the 158 wax may also act as a 152 slip additive and provide benefits for both reduced stickiness and reduced friction or the blown film.

Slip additives are modifiers that act as an internal lubricant to reduce the coefficient of friction (COF) between two overlapping films, for example, in films rolled after production. Indeed, lower COFs are especially desirable for film applications. These additives migrate to the surface of the plastic during and immediately after processing. That is, a non-visible coating “blooms” to the surface to provide a microscopic “layer” of “lubricant” between two adjacent sheets of film. In this way, enhanced lubricity and slip characteristics are provided. The previously described climate-controlled enclosure allows for some control over the migration of the slip additive.

Accordingly, slip additives may be considered similar to antiblock additives (discussed further below) in that they both serve to lower the COF between two overlapping films. Films of the instant invention may comprise one, both, or neither class of additives. Typical slip additives include, for example, oleamide, erucamide, stearamide, behenamide, oleyl palmitamide, stearyl erucamide, ethylene bis-oleamide, N,N′-Ethylene Bis(Stearamide) (EBS), including most grades of their respective refinement. In some embodiments, EBS is a preferred slip agent, and EBS with 4032D carrier is more preferred. EBS is sold under the tradenames Advawax, Lubrol EA, and Micotomic 280.

The “active ingredient” of slip additives is generally supplied with a carrier. Films of the present disclosure may comprise less than about 1 percent by weight of a slip additive (referring to the “active ingredient” only), and more preferably less than about 0.5 percent by weight. It should be noted that excessive amounts of slip additives may produce films that are excessively smooth, which can compromise the ability of substances (e.g., ink, stickers, etc.) to adhere to the surface of the PHA film. Thus, to enhance, for example, the printing properties of shrink films of the instant invention, the amount of slip additive may require adjustment accordingly.

Antiblock (also called “antitack”) additives serve to improve the processing and application of polymer films. Specifically, this class of additives is used to reduce the adhesion between films. Antiblock additives-typically finely divided, solid minerals-act by producing a slight roughening of the surface.

Antiblock additives are typically “loaded” with a carrier compound. While it is by no means a requirement, it is preferable that the carrier compound be similar to or equivalent to one or all of the polymers in the PHA blend base. In the instant invention, for example, it is preferred that the carrier compound be a PHA polymer. As the “active ingredient” in an antiblock comprises only a small fraction of the final composition, adding a carrier compound provides ease and consistency in measurements. One having ordinary skill in the art would recognize to take the concentration of filler into account when calculating the final concentration of antiblock additive in the final product. For example, if a composition comprising 10 percent antiblock additive consists of 10 percent “active ingredient,” the final concentration of the “active ingredient” is 1.0 percent of the total.

One example of an antiblock additive includes a silica additive. There are some benefits between adding antiblock additives such as silica and slip additives. Adding silica not only reduces blocking but allows less slip to be added to achieve the target coefficient of friction. Some types of antiblock additives, such as calcium carbonate, have been found to absorb slip additives, increasing the coefficient of friction. High levels of silica and other inorganic additives can result in a high haze. This can be alleviated by confining the inorganic to a thin outer layer. Inorganic additives like talc, carbonates, and anhydrates, have also been reported to react with some slip additives, resulting in degradation by-products with color or odor/taste issues. Other types of antiblock agents include paraffinics, ethylene and propylene oxide synthetics, fatty acide soaps, fatty acid amides, and silicons in addition to the aforementioned silicates.

The processing aids lower the surface friction of films, allowing the film to be rapidly extruded and then shipped or stored in rolls. They may also allow the resin to be converted easily in blown-film processes or thermoforming processes. Processing aids include several different classes of materials used to improve processability and handling. One such example of a processing aid is polyethylene glycol (PEG). One example of a processing aid is a viscosity enhancer.

Although numerous methods are known and available to increase the viscosity of polymers during the processing of blown films, the term “viscosity enhancer” is defined herein to encompass any chemical agent that increases or maintains the viscosity of a polymer at a given temperature. Viscosity enhancers may be introduced into the polymer blend at any time until the polymer enters the enclosure 122; however, viscosity enhancers are preferably introduced prior to extrusion, and more preferably, during blending of the bulk polymer material.

Viscosity enhancers can improve the finished properties of films by preventing and/or reversing the degradation encountered during the processing of polymer films. Some viscosity enhancers are “stabilizers.” That is, they are used in virgin plastic to either (1) protect against degradation in processing and/or (2) reverse the degradation caused by recycling, and return the plastic to nearly its original performance properties. Another class of viscosity enhancers, “coupling agents,” for example, improves the processability of the extruded polymer by “coupling” individual polymer strands thereby increasing the melt strength of the plastic.

Plasticizers, such as adipate, adipic acid, glycerol ester, and adipic acid ester, may be added to the biopolyester blown film. In some embodiments, the PHA blown film may be substantially free of a plasticizer, or entirely free of a plasticizer. In some embodiments, the PHA blown film may include about 2 wt % or less of a plasticizer, such as about 1 wt % or less, or about 0.1 wt % or less. The plasticizer may be included in the bulk polymer material as a pellet, bead, or grain.

PHA films or PHA blends have a narrow window for processing, approximately between about 340° F. to about 350° F., depending on the PHA blend and additives used. That processing window may narrow even more depending on the PHA to other biopolyesters blend ratio and other additives, further suggesting control of temperature through the blown film process may be crucial for developing a new type of compostable films such as PHA films. blend baseblend baseblend baseblend base

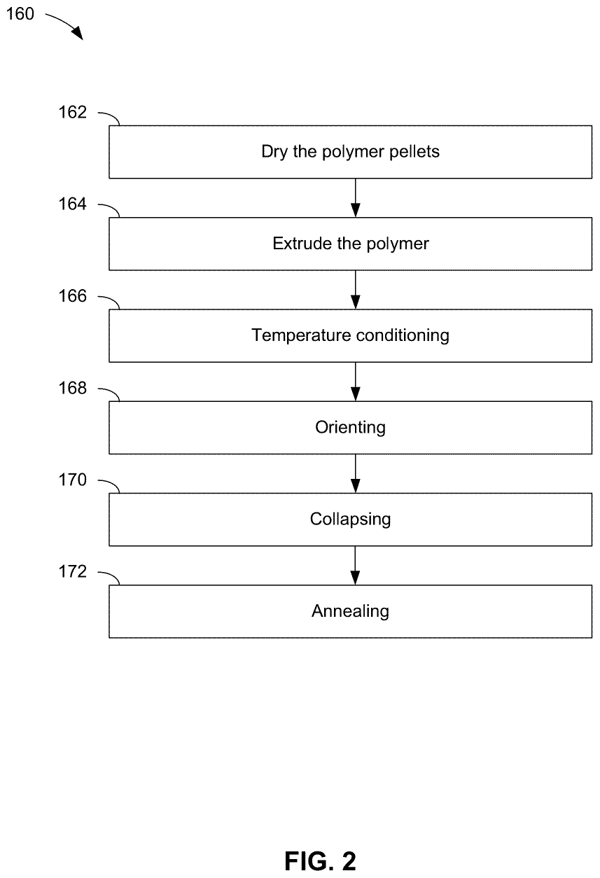

FIG. 2 illustrates a blown film process 160.

The process 160 begins with a drying step 162, which removes moisture from the bulk polymer material comprising the or PHA or the PHA blend base. The drying step may take place when the bulk polymer material is in a hopper, or may take place before the bulk polymer material is added to the hopper. PHA readily absorbs moisture from the atmosphere and therefore, the blended polymer pellets are preferably first dried by heating in a dryer to remove surface moisture. Without being bound by or limited to theory, it is believed that the removal of moisture content may help control the relative viscosity loss due to hydrolysis. As mentioned above, higher temperatures and the presence of even a small amount of moisture can hydrolyze PHA in the ensuing melt phase.

PHA is generally produced by a reversible condensation reaction, which produces water; when undried PHA is heated, hydrolysis can occur and key mechanical properties of the PHA may be compromised. For example, the viscosity of the polymer, when melted, is inversely proportional to the percentage of free monomer therein. Therefore, in an attempt to minimize batch-to-batch variation in viscosity, preferably, significant moisture is removed from the bulk polymer material. A moisture content of less than 0.04% (400 ppm) is recommended to prevent viscosity degradation during processing. The bulk polymer material may not be exposed to atmospheric conditions after drying, and the hopper may be kept sealed until ready to use. In some embodiments a moisture content of less than about 200 ppm is preferable, and less than about 50 ppm, more preferable (measured by the Karl Fisher method).

A dehumidifying hopper with hot air at a relatively low dew point may be used; however, a variety of air dryers are known in the art and many of them may be suitable for drying. The present invention need not be limited to air dryers only but may include other types of dryers, including convection ovens. A dehumidifying hopper may be desirable in some embodiments in that dehumidified air passes through a bed of PHA to extract moisture from the resin. A desiccant material, such as silica, absorbs moisture from the circulating air. Dual desiccant bed systems are common, so that one bed is on-stream while the stand-by bed is being regenerated. Either a time cycle or a predetermined decrease in air dew point is used to shift airflow from one bed to the other. Such methodology is thought to be effective in removing some moisture that may reside below the surface of the bulk polymer material in addition to the surface moisture.

Preferable dryers for use in the systems and methods of the present disclosure for drying PHA may have one or more of the following characteristics:
1. Desiccant beds capable of achieving a dew point of about −40° C. in the supply air;
2. A means, e.g., an after-cooling unit, to eliminate or reduce the likelihood of temperature spike in the supply air; or
3. Excellent temperature control in the PHA drying range.

The temperature and duration of the drying 162 may be dependent on the total amount and condition of the polymer(s) (e.g., the amount of starting surface moisture), and may need to be adjusted on a batch-by-batch basis. Preferably, the polymers experience little to no melting in this step. In a non-limiting example, drying conditions may include a duration of 4 hours at not greater than about 170° F. (80° C.) or to a dew point of about −40° F. (−40° C.), with an airflow rate greater than 0.5 cfm/lb of resin. By way of further example, typical drying conditions may include a temperature range from about 110° F. to about 230° F., and preferably from about 130° F. to about 190° F. for variable periods of time. By way of further example, the residence time for drying the polymer with air (dew point, −40° F.) at a flow rate of greater than about 0.5 ft³/min may be about 4 hours at about 110° F. and about 2 hours at about 190° F. Higher drying temperatures may lead to softening and blocking of polymer, while lower drying temperatures will result in extended drying times and/or incomplete drying.

Dew point is an absolute measure of air moisture and is independent of air temperature. Dew point may be used to control dryer performance. Airflow is another component of drying, as it heats the resin and absorbs its moisture. Sufficient airflow can maintain the resin at the proper temperature for its entire residence time. In embodiments where additional colorants, additives, or other ingredients are used, it may be preferable to minimize moisture-related degradation by further drying the same.

At step 164, the bulk polymer material is extruded. The bulk polymer material is melted into a low viscosity molten mass, thus combining the heretofore individual polymer pellets, beads or grains into one molten mass. The viscosity of the melt will depend on the temperature. Temperatures can range from about the temperature at which the polymers will remain melted to about the temperature where degradation of the polymers begins to occur. By way of example, extrusion melt temperatures may be maintained between about 340° F. to about 350° F. for certain PHA polymer blends, but may ultimately depend on the different polymers that have been blended and their respective melting points.

An optional temperature conditioning occurs at step 166. The temperature conditioning may be accomplished using a climate control system and/or polymer cooler as described above. By way of example, the viscosity of biopolymers at about 480° F. and an apparent sheer rate of about 5.5 seconds⁻¹ in a capillary rheometer may range from about 1,000 poise (P, dyne/cm²) to about 8,000 P, preferably about 3,000 P to about 6,000 P, and more preferably, about 4,500 P. At a shear rate of about 55 seconds⁻¹, the same polymer at about 480° F. may have an apparent viscosity that ranges from about 1,000 P to about 5,000 P, preferably about 2,000 P to about 4,000 P, and more preferably, about 3,000 P. The temperature conditioning step 166 is performed to increase the viscosity of the molten polymers, which makes the melt manageable for further processing. The cooling allows for the temperature of the extruded polymer to drop to a level at which the corresponding viscosity is high enough to allow a bubble to be blown. Furthermore, it is thought that by increasing the viscosity, a smoother film surface than without this step is generated. A smoother surface aids in the printing process that is performed in many end applications, such as, for example, labels.

Step 166 may be accomplished by a variety of methods known in the art, and a variety of coolers are known in the art and may be used by one of ordinary skill in the art based on the teaching provided herein. For example, the viscosity of the polymer melt may be adjusted, alone or in combination, for example, by air cooling the die inner mandrel through which the polymer film is blown, the use of viscosity enhancers noted above, controlling the die temperature with air or liquids, or polymer coolers. The temperature conditioning step 166 can be further continued during the bubble process within the enclosure 122 using the climate control system 124.

The polymer cooler operating temperature range can range between 290 to 395° F. in various embodiments. Higher temperatures may be used, but such higher temperatures may also contribute to the degradation of the polymer. The temperature and duration of cooling can again depend on both the amount of polymer being cooled and the film properties that may be desired. In other terms, the pressure in the primary loop for polystyrene cooling is generally about 1000 psi to about 7,000 psi and, in some instances, about 5,000 psi; by contrast, the pressure in the same loop adjusted for PHA use may range from about 300 psi to about 4,000 psi.

The polymers demonstrate a substantial increase in viscosity upon cooling in the polymer cooler, which cooling procedure, in part, is thought to allow for the subsequent blowing of the film. It is also apparent that the viscosity of the PHA polymers exhibits a consistent shear viscosity of a relatively large range of shear rates at any given temperature.

Next, orienting, also known as stretching, ocurrs at step 168. The orienting may be accomplished by many methods and associated equipment known to one of ordinary skill in the art, including, for example, machine/cross direction orientation and blown film orientation. All methods are preferably designed to first control the temperature of the polymer, followed by a controlled stretching operation. Without being limited to or bound by theory, it is believed that the orienting process conveys strength and flexibility to the film product. Furthermore, though orientation bubbles may be pulled either up or down from a die, it may be preferable to pull said bubble upward to facilitate control and maintenance of the polymer temperature during orientation.

In a preferred embodiment of the present invention, the polymer melt is already pre-cooled, preferably in a polymer cooler, and then submitted to a blown film orientation process. However, the viscosity of the polymer melt may also be adjusted, alone or in combination, for example, by air cooling the die inner mandrel, the use of viscosity enhancers, liquid thermoregulation of the die, or a combination thereof.

Die parameters may range from 1:0.75 BUR (Blown Up Ratio) to about 1:7.0 BUR, and preferably, about 1:4 BUR in the cross-web direction. In the length (or machine) direction, die parameters may range from about 1:1 drawdown ratio to about 1:300 drawdown ratio, and preferably, about 1:130 drawdown ratio.

In the preferred embodiment then, by virtue of pre-cooling the melted polymer, only a final fine-tuning of orienting temperature is performed, where desired, during the orientation process. In other words, the greater share of temperature conditioning takes place prior to orienting and not during orienting. Where a fine-tuning of temperature is desired, it can be relatively easily accomplished by a temperature-controlled air ring, which blows chilled air at the base of the bubble.

In another embodiment, the fine-tuning of the orienting temperature at step 168 is performed through the entire orienting step 168 until the collapsing step 170 by controlling the climate within the enclosure 122 with the climate control system 124 during the orienting step 168. The temperature of the orienting step may range from about 100° F. to about 160° F., such as about 130° F.

The collapsing step 170 is the fifth step in the process. Once the extrudate has been inflated into a circular bubble 112, it then is “collapsed” into a double thickness film. The collapsing process is performed by use of the collapsing frame 114. The collapsing frame 114 uses primary nip rollers 116, panels, and/or flat sticks to flatten the bubble 112 into a sheet of double-thickness film. The sheets are ultimately cut and wound onto two finished rolls of PHA film as described above.

In accordance with another embodiment of the present invention, it has also been learned that control of the film temperature while in bubble form may prevent the formation of undesirable wrinkles and/or film layers that stick together upon passage through the collapsing nip rollers. By control, it is meant that the temperature of the bubble 112 is preferably maintained within a preferred range.

The annealing step 172, also called crystallization, is the final step in the process 160. Annealing is generally accomplished after orienting, and performed at temperatures from about 100° F. to about 200° F. in some embodiments. Methods of annealing polymer films are generally known to those having ordinary skill in the art.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL.”

### Enumerated Embodiments

Embodiment 1: A method of making a polyhydroxyalkanoate (PHA) blown film, the method comprising: melting a composition including dry pellets comprising PHA to form a molten mass at a first viscosity from about 1400 P to about 1600 P at a first temperature from about 340° F. to about 350° F. at an apparent shear rate of about 55 s⁻¹; increasing the viscosity of the molten mass to a second viscosity; forming a bubble from the resulting molten mass within a climate-controlled enclosure; and collapsing the bubble to form a PHA blown film.

Embodiment 2: The method of embodiment 1, wherein increasing the viscosity of the molten mass comprises cooling the molten mass.

Embodiment 3: The method of embodiment 1 or embodiment 2, further comprising extruding the molten mass prior to increasing the viscosity of the molten mass.

Embodiment 4: The method of any one of embodiments 1-3, wherein the dry pellets further comprise a biopolystyrene selected from the group consisting of polylactic acid (PLA) (such as poly(L-lactic acid) (PLLA), poly(D-lactic acid) (PDLA), poly(D,L-lactic acid) (PDLLA) or PLA stereocomplex (scPLA)), polyglycolic acid (PGA), polycaprolactone (PCL), polybutylene succinate (PBS), polybutylene succinate adipate (PBSA), polybutylene adipate terephthalate (PBAT), and derivatives or combinations thereof.

Embodiment 5: The method of embodiment 4, wherein the biopolystyrene is present in the pellets in an amount no greater than 40% by weight.

Embodiment 6: The method of any one of embodiments 1-5, wherein the dry pellets further comprise a wax, an antiblock additive, a slip additive, a processing aid, or any combination thereof.

Embodiment 7: The method of embodiment 6, wherein the slip additive is selected from the group consisting of oleamide, erucamide, stearamide, behenamide, oleyl palmitamide, stearyl erucamide, ethylene bis-oleamide, N,N′-Ethylene Bis(Stearamide) (EBS), and any combination thereof.

Embodiment 8: The method of embodiment 6 or embodiment 7, wherein the antiblock additive comprises silica.

Embodiment 9: The method of any one of embodiments 6-8, wherein the processing aid comprises a viscosity enhancer.

Embodiment 10: The method of any one of embodiments 6-9, wherein the processing aid comprises polyethylene glycol.

Embodiment 11: The method of any one of embodiments 6-10, wherein the wax comprises EBS (ethylene-bis staramide) synthetic wax.

Embodiment 12: The method of any one of embodiments 1-11, further comprising drying the composition.

Embodiment 13: The method of embodiment 12, wherein the composition has a moisture content of about 400 ppm or less.

Embodiment 14: The method of any one of embodiments 1-13, further comprising annealing the PHA film.

Embodiment 15: The method of embodiment, wherein the annealing is performed at a temperature from about 100° F. to about 200° F.

Embodiment 16: The method of claim 1, wherein the PHA film is substantially free of plasticizer.

What is claimed is:

1. A method of making a polyhydroxyalkanoate (PHA) blown film, the method comprising:
melting a composition including dry pellets comprising PHA to form a molten mass at a first viscosity from about 1400 P to about 1600 P at a first temperature from about 340° F. to about 350° F. at an apparent shear rate of about 55 s⁻¹;
increasing the viscosity of the molten mass to a second viscosity;
forming a bubble from the resulting molten mass within a climate-controlled enclosure; and
collapsing the bubble to form a PHA blown film.

2. The method of claim 1, wherein increasing the viscosity of the molten mass comprises cooling the molten mass.

3. The method of claim 1, further comprising extruding the molten mass prior to increasing the viscosity of the molten mass.

4. The method of claim 1, wherein the dry pellets further comprise a biopolystyrene selected from the group consisting of polylactic acid (PLA) (such as poly(L-lactic acid) (PLLA), poly(D-lactic acid) (PDLA), poly(D,L-lactic acid) (PDLLA) or PLA stereocomplex (scPLA)), polyglycolic acid (PGA), polycaprolactone (PCL), polybutylene succinate (PBS), polybutylene succinate adipate (PBSA), polybutylene adipate terephthalate (PBAT), and derivatives or combinations thereof.

5. The method of claim 4, wherein the biopolystyrene is present in the pellets in an amount no greater than 40% by weight.

6. The method of claim 1, wherein the dry pellets further comprise a wax, an antiblock additive, a slip additive, a processing aid, or any combination thereof.

7. The method of claim 6, wherein the slip additive is selected from the group consisting of oleamide, erucamide, stearamide, behenamide, oleyl palmitamide, stearyl erucamide, ethylene bis-oleamide, N,N′-Ethylene Bis(Stearamide) (EBS), and any combination thereof.

8. The method of claim 6, wherein the antiblock additive comprises silica.

9. The method of claim 6, wherein the processing aid comprises a viscosity enhancer.

10. The method of claim 6, wherein the processing aid comprises polyethylene glycol.

11. The method of claim 6, wherein the wax comprises EBS (ethylene-bis staramide) synthetic wax.

12. The method of claim 1, further comprising drying the composition.

13. The method of claim 12, wherein the composition has a moisture content of about 400 ppm or less.

14. The method of claim 1, further comprising annealing the PHA film.

15. The method of claim 14, wherein the annealing is performed at a temperature from about 100° F. to about 200° F.

16. The method of claim 1, wherein the PHA film is substantially free of plasticizer.
